(19) United States
(12) Patent Application Publication
(10) Pub. No.: US 2016/0091609 A1
(43) Pub. Date: Mar. 31, 2016

(54) METHOD AND SYSTEM FOR AN ACCURATE AND ENERGY EFFICIENT VEHICLE LANE DETECTION

(71) Applicant: Umm-Al-Qura University, MAKKAH (SA)

(72) Inventors: Heba Allah Aly AbdEl-Halim Aly Ismail, Alexandria (EG); Anas Basalamah, MAKKAH (SA); Moustafa Amin Youssef, Alexandria (EG)

(21) Appl. No.: 14/661,272

(22) Filed: Mar. 18, 2015

Related U.S. Application Data
(63) Continuation of application No. PCT/IB2014/064939, filed on Sep. 30, 2014.

(51) Int. Cl. G01S 19/13

(52) U.S. Cl. CPC G01S 19/13

(57) ABSTRACT

Knowledge of the vehicle's lane position is required for several location-based services such as advanced driver assistance systems, driverless cars, and predicting driver's intent, among many other emerging applications. We present LaneQuest: a system and method that leverages the ubiquitous and low-energy inertial sensors available in commodity smart-phones to provide an accurate estimate of the vehicle's current lane. LaneQuest leverages the phone sensors about the surrounding environment to detect the vehicle's lane. For example, a vehicle making a right turn most probably will be in the right-most lane, a vehicle passing by a pothole will be in a specific lane and the vehicle angular velocity when driving through a curve reflects its lane. The ambiguous location, sensors noise, and fuzzy lane anchors; LaneQuest employs a novel probabilistic lane estimation algorithm. Furthermore, it uses an unsupervised crowd-sourcing approach to learn the position and lane span distribution of the different lane-level anchors.

### CROSS REFERENCE TO RELATED APPLICATIONS

The instant application is a continuation of a pending PCT application PCT/IB2014/064939 filed on Sep. 30, 2014. The pending PCT application is hereby incorporated by reference in its entireties for all of its teachings.

### FIELD OF TECHNOLOGY

The present invention relates to a method and system that leverages the ubiquitous and low-energy inertial sensors available in commodity smartphones to provide an accurate estimate of vehicle's current lane.

### BACKGROUND

Lane-level positioning systems for cars represent the next generation for outdoor navigation, where systems will not just predict the vehicle location on the road but also its exact driving lane. This fine granularity is required for a wide range of emerging applications including advanced driver assistance systems (ADASs) (Sabine Hofmann et al. 2009), autonomous cars (e.g. the Google driverless car), lane-based traffic estimation, electronic toll fee collection (André de Palma et al, 2011), and predicting driver's intent (Anup Doshi et al, 2011a and Anup Doshi et al, 2011b), among others.

A number of systems were proposed to provide finer lane level localization accurately (David Bétaille et al. 2010, Dong Li et al. 2012, Feixiang Ren et al. 2010. Zui Tao et al. 2013, Rafael Toledo-Moreo et al, 2010, and Rafael Toledo-Moreo et al. 2009). However, these systems require special sensors to be installed on all vehicles (e.g. the RF sensors in (Dong Li et al. 2012)) and/or an expensive calibration phase (e.g. (David Bétaille et al. 2010, Zui Tao et al. 2013, Rafael Toledo-Moreo et al. 2010, and Rafael Toledo-Moreo et al. 2009)), limiting their ubiquitous deployment. Computer vision based techniques, e.g. (Feixiang Ren et al. 2010), use a camera to detect the lane markings. However, using an image processing solution raises challenges for accurately predicting the lane whenever the road markings are unclear, line-of-sight is obstructed, and/or bad weather conditions. The process also uses extensive energy and processing power from smartphone battery.

Current state-of-the art outdoor car navigation techniques can only provide an accurate lane position for about 10 meters in urban environments (Heba Aly et al. 2013). While such accuracy may be enough for ordinary vehicle location based services (Heba Aly et al. 2014 and Kenneth Wai-Ting Leung et al. 2011), it fails to estimate the vehicle's exact lane position. There is a need for a more accurate and ubiquitous solution.

### SUMMARY

In the present disclosure, we propose a method and system (LaneQuest), that leverages the ubiquitous sensors available in commodity smartphones to automatically predict lanes in which the vehicle is travelling.

In one embodiment, the LaneQuest system leverages the ubiquitous sensors available in commodity smartphones to provide an accurate and energy-efficient estimate of the car's current lane. LaneQuest starts the calculation by using an ambiguous location data estimate, e.g. reported by the GPS for driving events detected by the phone sensor.

In one embodiment, specifically LaneQuest uses the low-energy inertial sensors measurements to recognize unique motion events while driving such as changing the lane, turning right, or passing over a pothole. These events or “lane anchors” provide hints about the car current lane. For example, a car making a left turn most probably will be in the left-most lane; similarly, potholes typically span only one lane, allowing detecting the lane of cars that pass through them.

In one embodiment, a method to reduce the ambiguity in lane estimation is done by using a crowd-sensing approach to detect a large class of lane anchors as well as their positions through the road network and the lanes they span.

In one embodiment to mitigate the sensors' noise, location ambiguity, and error in anchors location estimation, LaneQuest, as a method, models the lane estimation problem as a Markov lane detection problem. The attributes that are used for this calculation are the vehicle motion events (such as changing lanes) with lane anchor detection in a unified probabilistic framework. In one embodiment, LaneQuest was implemented on different android devices and evaluated in different cities covering more than 260 km, the results show that the method and system may detect the different lane anchors with an average precision and recall of 93% and 91% respectively. In another embodiment, the accuracy of detection of the car lane was more than 70% of the time, increasing to 89% to within one lane error. In another embodiment, LaneQuest has a low-energy profile when implemented along with different localization techniques.

The present invention also relates to a method that defines a differentiation of analysis done on the data from sensors in smartphones from those who are in the vehicle and those who have driven many times and observed (crowd-sourced data) for motion based changes (moving right and left) and anchor based (curves, potholes, tunnels etc.) changes.

In one embodiment, architecture of LaneQuest is disclosed as an energy efficient crowd-sensing system that leverages the sensed lane-anchors and vehicle's dynamics to provide an accurate estimate of the car's current lane without any prior assumption on the cars starting lane position.

In one embodiment, a unified probabilistic framework for robust detection of vehicles' driving lane is disclosed. A method is designed to use a crowd-sensing approach for detecting the position and lanes of different types of lane-level anchors. The proposed method captures the inherent ambiguity in the crowd-sensing process. In one embodiment the system and method uses android as an operating system but is not limited to it.

In one embodiment, the LaneQuest architecture, system and method is designed to automatically crowd sense and identify anchor semantics from available sensor readings without inferring any overhead on the driver and with minimal energy consumption. In one embodiment, the method of extracting the different motion and anchor features from both driver smartphone and crowd-sourced data is performed. In one embodiment, the geographical range of LaneQuest on Android devices spans up to 260 KM.

In one embodiment, predicting the probability that a vehicle is in a particular lane at a given time using organic lane anchors data and probabilistic calculation method is done. The method of calculating probabilistic data gets the input from both motion model and perception model.

In one embodiment, LaneQuest accepts input from the phone sensors about the surrounding environment to detect the vehicle's lane. For example, a vehicle making a right turn most probably will be in right most lanes, a vehicle passing by a pothole will be in a specific lane and a vehicle's angular velocity when driving through a curve will reflect its lane. In another embodiment, the ambiguity of location, sensors noise and fuzzy lane anchors are also used by LaneQuest to calculate by using a novel probabilistic lane estimation algorithm. LaneQuest also uses an unsupervised crowd-sourcing method to learn the position and lane span distribution of the different lane-level anchors, in one embodiment.

Other features will be apparent from the accompanying figures and from the detailed description that follows.

### BRIEF DESCRIPTION OF THE DRAWINGS

Example embodiments are illustrated by way of example and no limitation in the graph and in the accompanying figures, like references indicate similar elements and in which:

FIG. 1 illustrates the technology progression in car lane position detection mechanism. Initially the vehicles had no detection capability, followed by approximate detection possible with general devices. Of late, expensive sensor based products have been used for car lane predictions. The proposed LaneQuest methodology provides inexpensive and accurate detection of the position.

FIG. 2 shows the approximate nature of car position detection (206) when a general device such as GPS is used.

FIG. 3 provides a high level architecture and stages on how the proposed LaneQuest methodology uses various sensors and devices to get initial location information, and fine tune it to increase the accuracy of the position.

FIG. 4 shows the proposed LaneQuest methodology's system architecture.

FIG. 5 shows the probabilistic lane estimation basic idea: At the start, the car's lane is unknown. As the car moves to the adjacent right lane the distribution moves to the right since, most probably, it is not at the left-most lane anymore. Finally, as the car encounters a landmark, its lane is mostly known as the landmark's lane.

FIG. 6 illustrates the correlation between vehicle's turn and the impact on the orientation sensors.

FIG. 7 shows step by step, the proposed probabilistic methodology to achieve an accurate estimate of the user's current lane.

FIG. 8 shows the impact of a lane change on the X-acceleration and orientation of sensors.

FIG. 9 shows the rotational implication on change of vehicle direction and acceleration.

FIG. 10 shows the decision tree used to identify lane-known anchors.

FIG. 11 illustrates the relationship between the centripetal acceleration, tangential speed and angular velocity when the vehicle is moving over a curved road leading to accuracy in lane prediction for a turning vehicle.

FIG. 12 shows the graph illustrating the estimation of the turn by sensors based on the lane positioning of the vehicle.

FIG. 13 shows the graph illustrating the impact on the variance in x-magnetic field of sensor to the effect of a vehicle moving inside the tunnel verses outside the tunnel.

FIG. 14 shows the multi-step process of unsupervised crowd-sourcing approach used by the proposed LaneQuest methodology to learn the road location and lane distribution of the organic lane anchors.

FIG. 15 shows the probabilistic lane estimation flowchart based on Markovian model.

FIG. 16 shows the efficacy of the proposed LaneQuest methodology by illustrating that the method can identify different lane anchors with an average precision and recall of 0.93 and 0.91.

FIG. 17 illustrates the effect of number of points within a cluster traces on the accuracy of identifying the lane-anchors.

FIG. 18 shows the cumulative distribution function of lane estimation error when LaneQuest methodology is used, compared to approximate prediction mechanism using common GPS sensors.

FIG. 19 shows the power consumption for different systems when integrated with the proposed LaneQuest method.

Other features of the present embodiments will be apparent from the accompanying detailed description that follows.

### DETAILED DESCRIPTION

The present disclosure relates to a method and system to accurately predict a stationary or moving vehicle's lane.

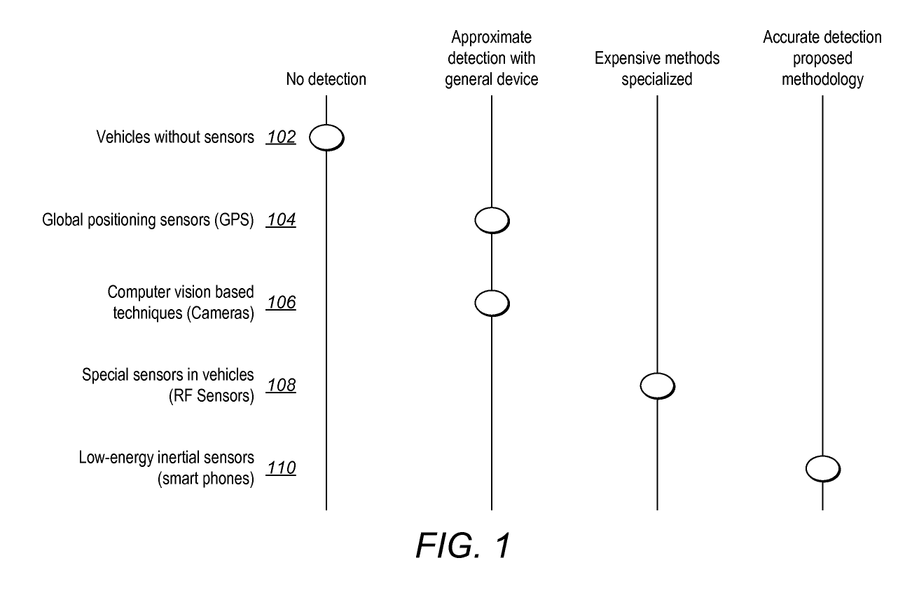

FIG. 1 shows technology progression in vehicle lane position detection. Initially, vehicles had mostly mechanical entities with very few electronic components in them. Therefore there were no general purpose sensors 102 and hence there was no concept of lane position detection at all. When vehicles evolved to have some rudimentary electronic sensors such as Global Positioning Sensors (GPS) 104, approximate detection was possible. Even when the vehicles have computer vision based cameras 106 installed in them; the lane position detection was only approximate. Computer vision based techniques, use a camera to detect the lane markings, leading to lower accuracy due to line-of-sight obstruction and weather conditions. Specific industries, such as safety and security agencies use special sensors 108 in vehicles (Example—RF sensors) which tend to be very expensive, specialized and not commonly available. However, of late the low energy inertial sensors 110 are available readily even in smart devices that can provide data on a periodic basis. Proposed methodology uses many of these sensor information intelligently and inexpensively to derive an accurate prediction of the vehicle lane position.

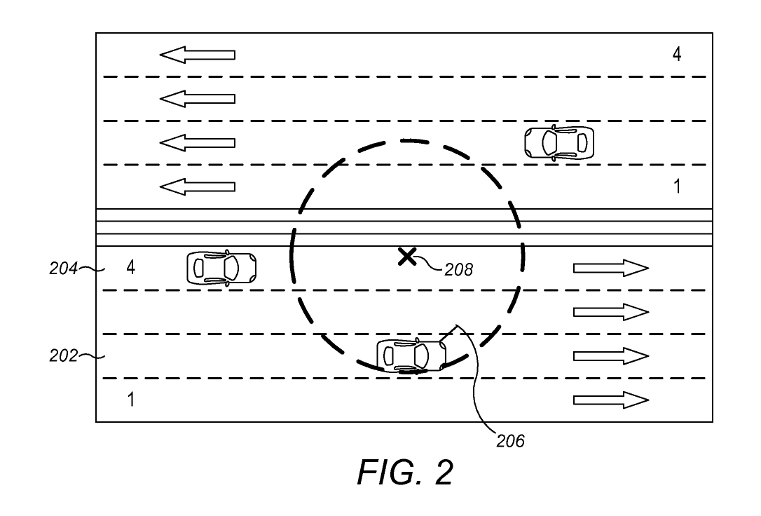

FIG. 2 shows that the current outdoor localization technologies fail to provide enough accuracy to estimate the car lane position. Current state-of-the-art outdoor vehicle navigation techniques can only provide an accuracy of about 10 meters in urban environments. The “x” mark 208 denotes the GPS position and the circle the associated error. While the vehicle 206 is moving in the second lane 202, an error around 3 meter moves its estimate to the fourth lane 204. A number of systems were proposed to provide finer lane level localization accuracy. However, these systems require special sensors to be installed on all vehicles and/or an expensive calibration phase limiting wide deployment and adoption.

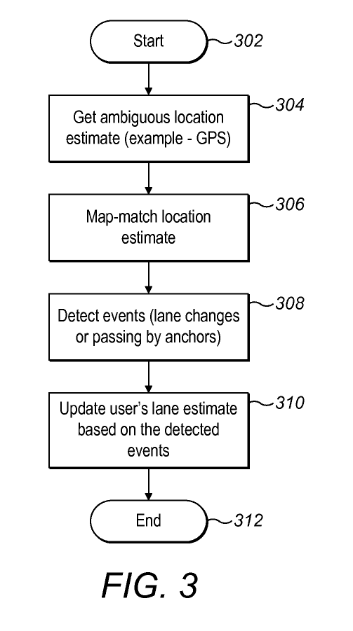

FIG. 3 shows the high level architecture and stages of the proposed LaneQuest methodology to achieve accurate vehicle position. Initially 302 an approximate location estimate 304 is obtained using sensors such as GPS that are available in the vehicle. The location estimates are enhanced using map-matching 306. Also, the low-energy inertial sensors (commonly available in smartphones) are used to detect when the vehicle changes its lane or passes by a lane-anchor 308. Then, the vehicle's lane estimate is updated using the proposed probabilistic framework based on the lane change and/or lane-anchor events 310.

LaneQuest leverages the ubiquitous sensors available in commodity smartphones to provide an accurate and energy-efficient estimate of the vehicle's current lane. Starting from an ambiguous location estimate, e.g. reported by the GPS 304, LaneQuest leverages driving events detected by the phone sensor to reduce this ambiguity 306. Specifically, LaneQuest uses the low-energy inertial sensors 306 measurements to recognize unique motion events while driving such as changing the lane, turning right, or passing over a pothole. These events or “lane anchors” provide hints about the vehicle's current lane. For example, a vehicle making a left turn most probably will be in the left-most lane; similarly, potholes typically span only one lane, allowing detecting the lane of cars that pass through them. LaneQuest uses a crowd-sensing approach 308 to detect a large class of lane anchors as well as their positions through the road network and the lanes they span, exploiting them as opportunities for reducing the ambiguity in lane estimation.

To handle the sensors' noise, location ambiguity, and error in anchors location estimation, LaneQuest models the lane estimation problem as a Markov lane detection problem 310 that combines the vehicle motion events (such as changing lanes) with lane anchor detection in a unified probabilistic framework 312. We have implemented LaneQuest on different android devices and evaluated it using driving experiments at different cities covering more than 260 km. Our results show that LaneQuest can detect the different lane anchors with an average precision and recall of 93% and 91% respectively. This leads to accurately detecting the vehicle's lane with more than 70% of the time, increasing to 89% to within one lane error. Moreover, LaneQuest has a low-energy profile when implemented on top of different localization techniques.

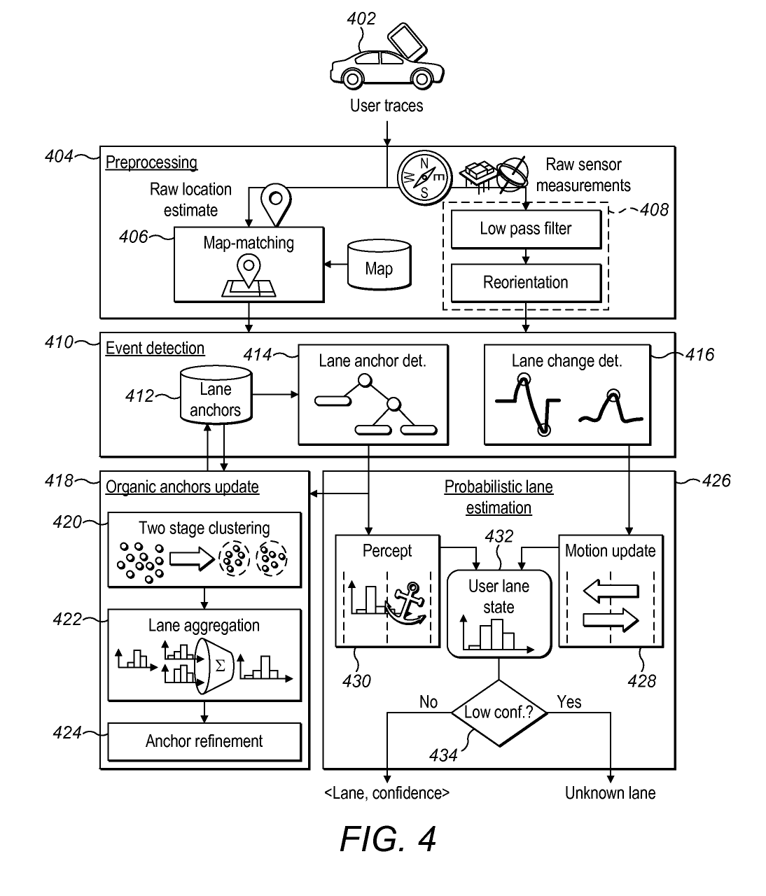

FIG. 4 shows an overview of the LaneQuest architecture for vehicle position tracking accurately using inexpensive sensor enabled smart devices 402. LaneQuest estimates the car's lane position using inertial sensors available on a smartphone attached to the vehicle's windshield or a dashboard mount. It leverages the vehicle dynamics and detects anchors. LaneQuest predicts the vehicle's current lane using probabilistic approach by fusing knowledge of the vehicle lane changes and a repository of lane-level anchors. Crowd-sourced traces are also used to detect new anchors and identify their lane position in an organic way.

The architecture has four main components: The Preprocessing module 404, the Event Detection module 410, the Probabilistic Lane Estimation module 426 and the Lane Anchor update module 418. The Preprocessing module 404 is responsible for processing the raw input sensors 406 and location data to reduce the noise 408. LaneQuest collects time and location stamped measurements from the energy efficient inertial sensors in the smartphones. These include the accelerometer, gyroscope and magnetometer. To handle the noise in the sensors readings, we apply a local weighted low-pass regression filter. In addition, we also transform the sensor readings from the mobile coordinate system to the car coordinate system leveraging the inertial sensors. After this transformation, the sensors y-axis points to the car direction of motion, x-axis to the left side of the car, and z-axis is perpendicular to Earth (pointing to the car ceiling). For location information, LaneQuest does not require a specific localization technique; it can leverage GPS, network based localization techniques or other more accurate and energy-efficient GPS-replacement techniques. To further enhance the input location accuracy, we apply map matching to align the car's location estimates to the road network 406.

The event detection module 410 detects unique signatures of driving patters to give clue about vehicle's current lane. LaneQuest detects two type of events lane change events 416 and encountering lane anchors 414. LaneQuest differentiates between two types of lane anchors 412: Boot-strap anchors have a clear pre-known lane distribution across the road. For example, stopping a car occurs in the rightmost lane; a U-Turn is initiated in the left-most lane, and a right-turn happens with high probability in the right-most lane. On the other hand, organic anchors have unique signatures across the different lanes but their lane distribution cannot be pre-known and need to be learned. For example, a pothole can be detected by the phone sensors, though we do not know apriori in which lane this pothole is located. LaneQuest uses an unsupervised crowd-sourced approach to capture these anchors and identify their lanes distribution 418.

LaneQuest uses a probabilistic estimation technique 426 to derive the probability distribution of the vehicle being in a particular lane. The sensors continuously monitor sensors data, and if a motion event is detected, either moving left or right, the motion update model 428 kicks in. If the vehicle passes an anchor, then the perception model 430 kicks in. Based on the detected events, the user lane state 432 is updated and verified whether it is within the confidence interval 434 to accept as a lane estimate or not. Finally, the organic lane anchor update module 418 is used for estimating the road localization and lane distribution of organic anchors such as curves and pot holes 412. It uses crowd-sensing approach, where the information about the detected lane anchors by different users are collected and processed to estimate the anchor location and lane distribution. This is done by two stages clustering 420, first using lane anchors and then spatial clustering, followed by lane aggregation per clustering 422, leading to anchor refinement 424. These lane anchors are saved in a repository 412 for usage in lane-anchor detection.

To achieve robust and accurate lane estimates based on the noisy inertial sensors measurements, the ambiguous vehicle locations, human driving anomalies, and fuzzy lane anchor locations; LaneQuest uses a probabilistic estimation technique 426. Specifically, lane estimation technique is based on Markov Localization, which is known in the robotics domain for addressing the problem of state estimation from noisy sensor data. Instead of maintaining a single hypothesis about the robot location, Markov localization uses a probabilistic framework to maintain a probability density over the set of possible locations. Such a density can have an arbitrary form representing various position beliefs, including multi-modal distributions. Markov localization can deal with ambiguous situations and it can re-localize the robot position in the case of localization failures. The basic assumption in Markov localization is that the current state, i.e. the current robot location, captures the entire movement history (Markov assumption). That is, the current position is the only state in the environment which systematically affects the sensors readings.

Organic Lane Anchors Updates Module 418 is responsible for estimating the road location and lane distribution of organic anchors such as curves and potholes. It uses a crowd-sensing approach, where the information about the detected lane anchors by different system users is collected and processed to estimate the anchor location and lane distribution based on the reporting vehicle's lane distributions.

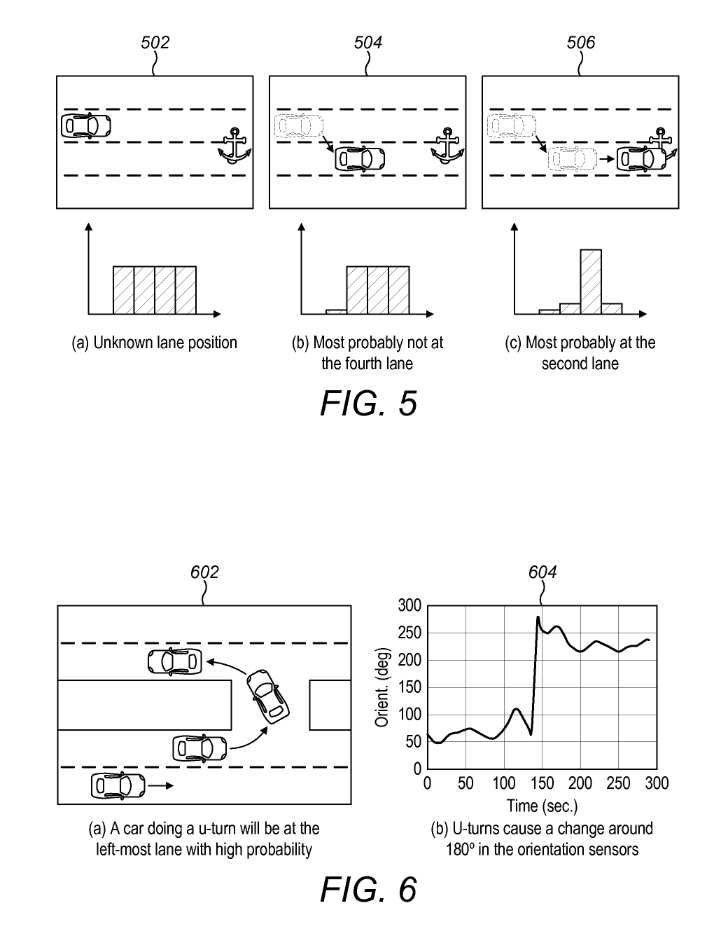

FIG. 5 illustrates the probabilistic lane estimation methodology. Initially the vehicle's lane is not known 502. As the vehicle moves to the right lane, the distribution 504 moves to the right, showing that the vehicle is most probably not in the left most lane. Finally, when the vehicle passes an anchor (a landmark) 506, the distribution captures the event to project the most probable lane to be the second lane. Accordingly, LaneQuest uses Markov localization to maintain a probability distribution over all possible lanes. This probabilistic representation allows it to weigh the different hypotheses and reach a more accurate lane estimate in a mathematically principled way. LaneQuest does not make any assumption on the starting lane position of the vehicle. This is modeled as a uniform distribution across all lanes. Then, as the car moves on the road, any cues for the car motion (i.e. lane changes) or detected lane anchors (e.g. a pothole) are used to update this lane belief distribution. For example, assuming a vehicle is moving on a four-lane road and it made three right lane changes, each time a lane change is detected the car's lane position distribution is updated. After the third lane change, the car is at the right-most lane with high probability. Similarly, if we know that the road has a pothole at the second lane around the current car location and the car encounters it, then most probably it is at the second lane 506.

FIG. 6 illustrates the impact of a U-Turn by a vehicle 602 on the sensors 604. When the Vehicle does a U-Turn 602, it needs to do a sharp turn around. The U-Turn causes a change of orientation of about 180 degrees and the graph clearly shows an instantaneous climb in the orientation 604. When making a U-Turn, the car is most probably at the left-most lane before and after the U-Turn 602. Therefore, noting that the car's direction changes by around ±180° when making a turn, which can be captured using the smartphone's orientation sensor 604 using the Lane Anchor Detection module, this “U-Turn anchor” hint is used by LaneQuest to reduce the ambiguity of the vehicle's current lane.

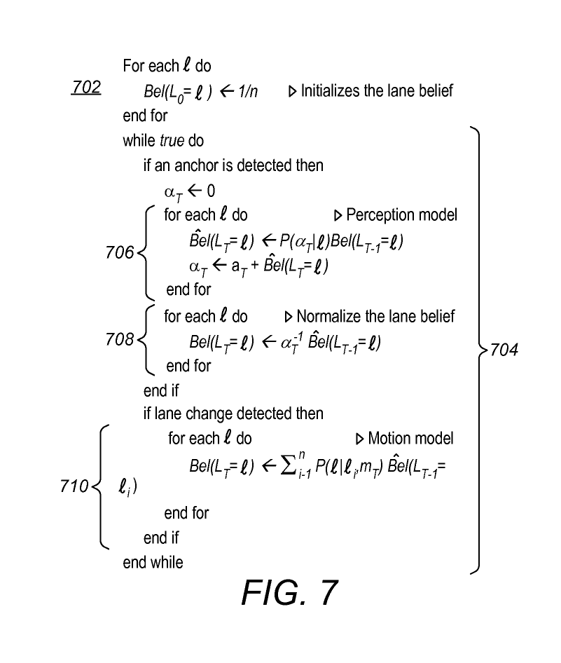

FIG. 7 provides the details of the LaneQuest novel probabilistic lane estimation methodology. This methodology is used to calculate the probability that the vehicle is in lane 1 at time T. The calculation is done for each lane so the distribution can be obtained. Based on the distribution table, the possible lane to which the vehicle has moved (based on motion model 710) or the lane in which the vehicle is travelling (based on perception model 706, 708) can be easily calculated.

Let lₜ, denote the actual vehicle's lane position at time t and Lₜ denote the corresponding discrete random variable. lₜ can take values from 1 to n; where n is the number of lanes. The belief about the vehicle lane position at time t is Bel(Lₜ), which is the probability mass function representing the distribution. Initially, the value of Bel(L₀=1) is 1/n, since it is equally likely that at the start vehicle could be in any lane and chance of it being in any particular lane is 1/n 702. Let eₜ denotes the event detected at time t. The system can detect two types of event: motion events mₜ (i.e., lane changes to left or right) and lane anchor detection event aₜ (example. pothole or a U-Turn). The system continuously monitors the vehicles's dynamics for lane estimation 704.

Whenever the system detects an anchor a_{T}, perception model is used to detect the lane accurately. As per perception model 706, Probability that the vehicle is in lane 1, given an anchor e is detected can be calculated based on Markovian model.

P(Lₜ=l|e)=α_{T}P(α_{T}|L_{T}=l)P(L_{T}=l|e₀, . . . ,e_{T-1})

Again, this can be put in a recursive form as:

Bel(Lₜ=l)=(α_{T})P(α_{T}|L_{T}=l)Bel(L_{T-1}=l)

Where the term α_{T} denotes a constant 1/P(a_{T}|e₀, . . . , e_{T-1}). The term Bel(Lₜ=1) represents the perception model 706 which is normalized based on the term α_{T} calculation 708. In the methodology, the value is calculated for each lane 1 to determine the distribution.

Whenever the system detects a lane change through the sensors, motion model 710 is used to calculate the probability that the vehicle is in lane 1. Again Markovian model is used to calculate the probability is calculated for each lane 1 to determine the distribution:

Bel(L_{T}=l)=P(Lₜ=l|e)=Σᵢ₌₁ⁿP(L_{T}=l|m_{T},L_{T-1}=lᵢ)P(L_{T-1}=lᵢ|e₀, . . . ,e_{T-1})

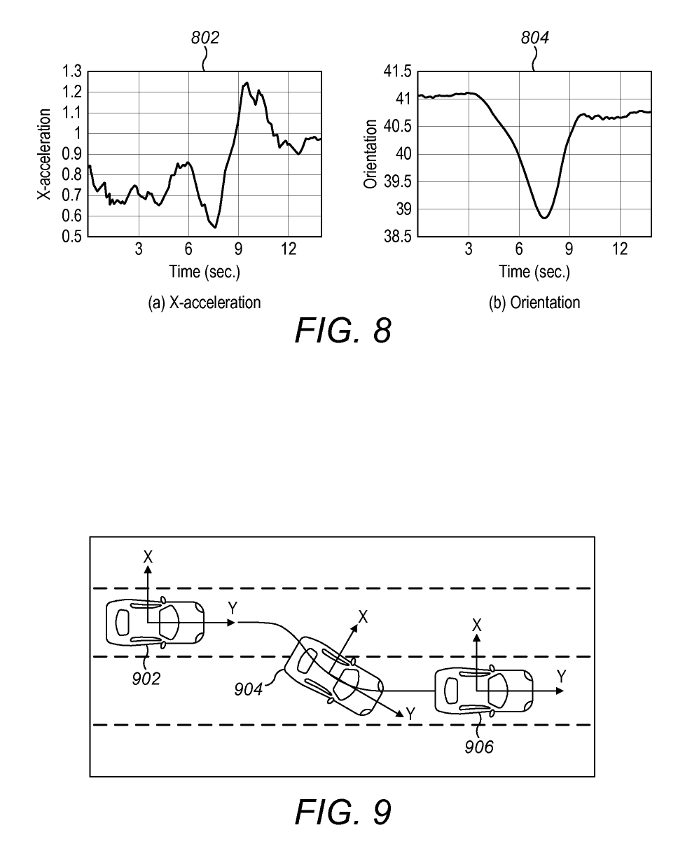

LaneQuest detects the motion events (i.e. lane change). Drivers typically change their lanes while driving for several reasons including: a) the current lane is ending/merging b) the driver plans to make a turn at an upcoming intersection, or c) the driver wants to move to a faster/slower moving lane. FIG. 8 shows the technique using the phone inertial sensors to detect the car lane change event. FIG. 9 shows a vehicle doing a lane change 902 will have to make a small rotation 904 around z-axis, leading to a change in its x-axis acceleration followed by stabilized x-axis 906. The vehicle experiences a rotation around z-axis of the accelerometer and affects mainly the x-acceleration. Assuming that the vehicle is making a left-lane change, x-acceleration 802 reading first decreases to a low value and then increases back to a higher value. It also minimally affects the phone's orientation. The x-acceleration pattern is not unique to a lane-change event and can happen in other cases when the car changes its direction, e.g. due to taking a turn or moving over a curve. This makes it harder to separate the lane-change events. To make our lane change detection more robust, we propose a new technique to separate between lane changes and other cases using the orientation variance 804. The idea is that, typically, curves and turns will cause the vehicle to have much higher variations as compared to lane-changes. We designed a threshold-based algorithm on both x-acceleration 802 and orientation 804 where we detect the maximum and minimum peaks within a window and detect a lane change event only if the difference between them is high while the variance in orientation is low. The direction of the lane change is then detected based on the order of the maximum and minimum peaks.

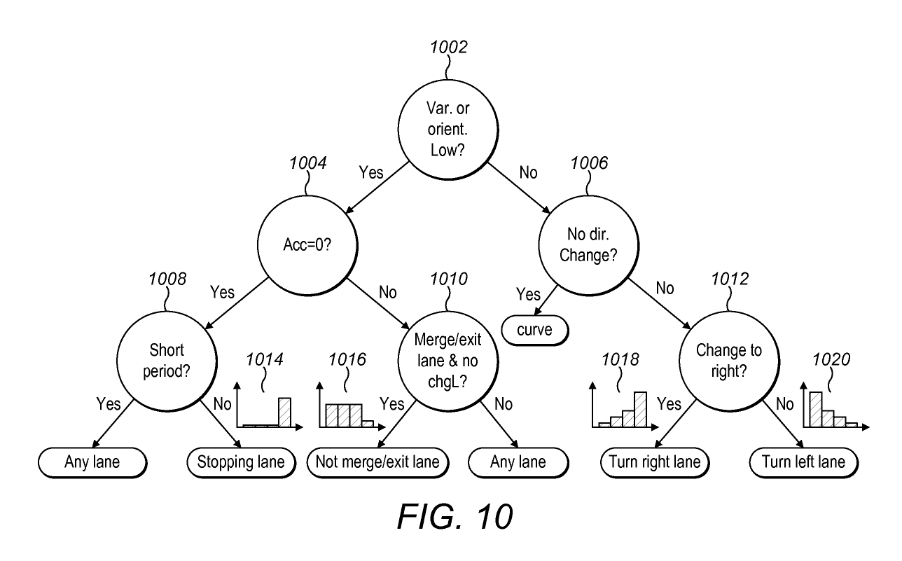

Similarly, LaneQuest also detects anchors to determine the lanes. LaneQuest defines bootstrap anchors as anchors that have unique sensors signature and a priori known lane distribution. These anchors include turns, merging and exit lanes, and stopping lanes. For the rest of this subsection, FIG. 10 shows the decision tree used to identify the bootstrap lane-anchors.

Turns: Turns and U-Turns force the vehicle to change its direction by around 90° and 180° respectively, which results in a big variance in the vehicle's orientation 1002 along with a change in its final orientation when it ends 1006. This was captured using the phone's orientation sensor 604 as shown in FIG. 6. To further differentiate between right and left turns, the difference between the starting and ending direction can be computed or the x-acceleration can be used as it results in patterns similar to the lane-change event. Since the driver should make a turn only from the closest lane, the lane distribution for turn anchors 1018 and 1020 is a skewed distribution according to the turn type 1012.

Merging and Exit Lanes 1010: A merging lane is used to merge traffic between two roads. Similarly, an exit lane is used to exit a road, e.g. a highway, to another. Usually these lanes have a special extra lane to the main lanes on the road. The location of these lane anchors can be extracted from the digital map and passing by them can be detected based on the car's map matched location. These lanes are usually the last lanes to the right or left. Therefore, if a vehicle uses an exit or merge lane, its lane distribution will be skewed 1016. Note also that not taking an exit or merge lane indicates that the vehicle is not located in these special lanes. This negative information can be associated with the complement distribution of this type of anchors.

Stopping Lanes: A vehicle may only park in the right-most lane of a driving road. However, traffic signals and road congestion can make a car stop at any lane. To differentiate between parking and the other cases, we use a simple time filter, where parking is detected only if the vehicle stops 1004 for more than 3 minutes 1008. A parking anchor distribution 1014 clusters mainly on the rightmost lane only and have small weights for the other lanes.

Organic Lane Anchors: LaneQuest also defines organic anchors which have unique sensors characteristics across the different lanes. However, their lane distribution and road position cannot be predetermined without war-driving. These anchors include curves, tunnels, and potholes.

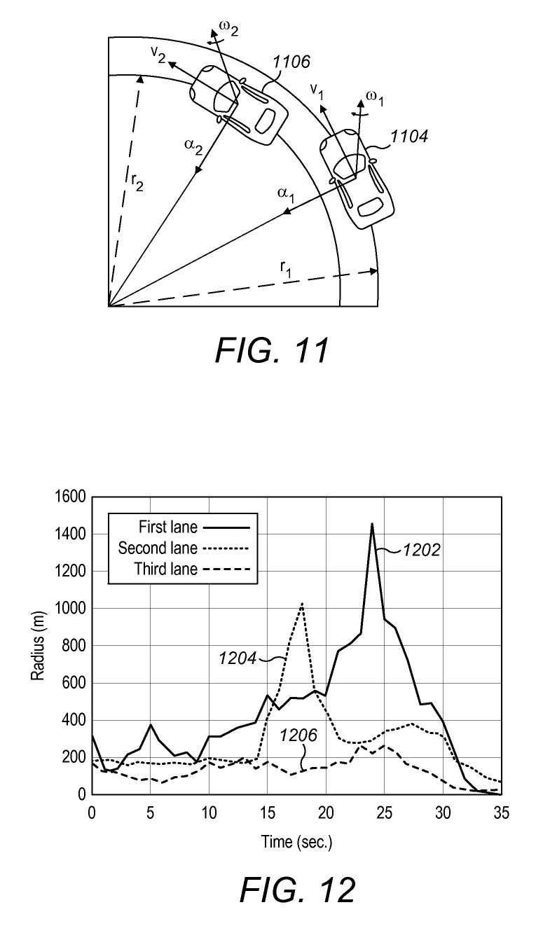

Curves: FIG. 11 shows while moving over a curved road 1104 and 1106 with radius rᵢ, the magnitude of the centripetal acceleration (aᵢ) is related to the tangential speed (vᵢ) and angular velocity (wᵢ). When a vehicle drives over a curved-road with radius r, the direction of its tangential velocity vector (v) changes as it rotates over the curve. The rate of the direction change is the centripetal acceleration (a), which always points inwards along the radius vector of the circular motion. Without this acceleration, the vehicle would move in a straight line, according to Newton's laws of motion. Based on the circular motion laws, the magnitude of the centripetal acceleration (a) is related to the tangential speed (v) and angular velocity (w) as v²/r, which is w²r. FIG. 12 shows an example of the radius estimated for road curves at different lanes 1202, 1204, and 1206. We can see a clear distinction between them.

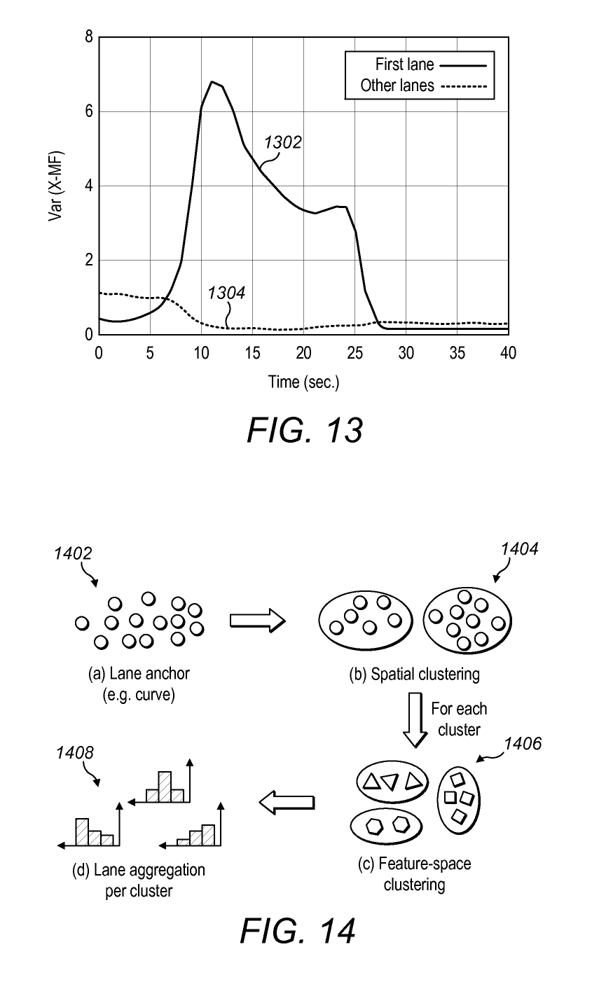

Tunnels: Going inside a tunnel causes a drop in the cellular signals for all the heard cell-towers. This drop can be used to detect the tunnel, but not the specific lane inside the tunnel as it is sensed in all lanes. Studying the effect of moving inside large tunnels with a number of lanes, we noticed a large variance in the ambient magnetic field in the x-direction (perpendicular to the car direction of motion) while the car is going inside the tunnel and going out of the tunnel. This can be explained by the metal and infrastructure (e.g. electricity lines) that exist on the side of the tunnel structure. FIG. 13 shows that the high variance decreases as you move away from the tunnel's side where the infrastructure is installed. This is expected as magnetic interference is known to have an effect on smart-phone's magnetometer within small distances. As the car goes inside and outside the tunnel, it experiences a higher variance 1302 in x-magnetic field. As we move away from the lane close to the infrastructure the variance decreases 1304.

Potholes and other anomalies: Anomalies in the road surface such as potholes span only part of the road compared to traffic calming device (e.g. bumps and cat's eyes), which spans the whole road. We identify such anomalies using thresholding on the variance of the z-gravity acceleration. However, this leads to an ambiguity with other traffic calming devices. To resolve this ambiguity, we further use our unsupervised learning approach. Typically, a traffic calming device such as a bump will have a uniform distribution over all lanes compared to a pothole that has a narrow distribution.

Automatic Detection of Organic Lane Anchors: Organic anchors have known sensors signature but their exact location in the road and their probability distribution across the lanes cannot be predetermined unless a calibration phase across the area of interest is employed. Typically, this imposes an arduous data collection at the different lanes for the entire area. To reduce this overhead, we propose an unsupervised crowd-sourcing approach for identifying these lane-anchors profile. Specifically, for each identified road anchor (e.g. a curve lane), we aim to determine its road location as well as its lane span distribution. Our analysis shows that, in general, our lane-anchors expose different signatures across the road's lanes. FIG. 14 shows the three step process to determine the lane anchor profile. Without loss of generality, we use the curve lane anchor 1402 as an example. First, we apply spatial clustering 1404 on all samples collected from all users that are detected as curves. This separates the different curves over the area of interest. The road location of the lane anchor is taken as the centroid of all points within this cluster. Second, for each resulting cluster (representing one specific curve), we do a second level clustering of its points based on the lane-discriminating features 1406 to separate the curve lane anchors. This helps in determining the lane position for a given lane anchor. Third, the curve lane anchor probability distribution P(all) which is the probability that vehicle was in lane 1 when it passed anchor a, is constructed from all the reported vehicle lane beliefs for the points within this last resulting feature based clustering step 1408. Finally, we note that we apply a density-based clustering for the two level clustering algorithms.

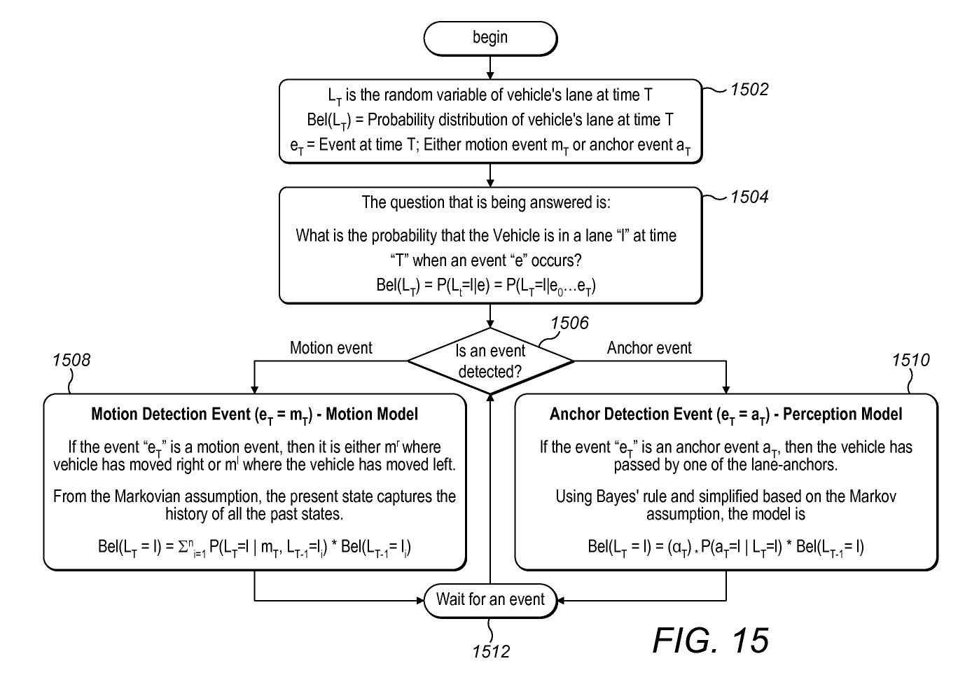

To summarize, FIG. 15 elaborates on the probabilistic lane estimation, where Bel(L_{T}) is the probability distribution of vehicle's lane at time T 1502. The estimation method calculates the probability that the vehicle is in lane 1 at time T when an event e_{T} occurs 1504. If the event is a motion event, namely the vehicle moving left or right captured through inertial sensors, then the probability distribution is calculated based on Markovian model 1508. If the event is an anchor event where a landmark was passed by the vehicle, then the probability distribution is calculated based on the recurrence equation 1510. The method is continuously active 1512, updating the lane estimate for every event detected 1506 thus calculating the vehicle's path.

Motion Detection and Bootstrap Anchor Detection Accuracy: LaneQuest was implemented and tested on different android devices including HTC Nexus One, LG Nexus 4, LG D686, Samsung Galaxy Note and Nexus. The system was evaluated over 200 KM geographical area. Table below shows the confusion matrix for detecting the motion events (i.e. lane change) and the related anchors (i.e. turns and curves). The table shows that we can detect the lane-changes, turns, and curves with high accuracy. This in turn enables high accuracy in lane estimation.

TABLE 1
Confusion matrix for the lane change events and the
related anchors (curve) using a total of 113 traces.

| | Turn | ChgL-R | ChgL-L | Curve | Straight |
|---|---|---|---|---|---|
| Turn | 27 | 0 | 0 | 0 | 0 |
| ChgL-R | 0 | 14 | 0 | 0 | 0 |
| ChgL-L | 0 | 0 | 16 | 0 | 0 |
| Curve | 0 | 2 | 0 | 20 | 0 |
| Straight | 0 | 0 | 4 | 0 | 30 |

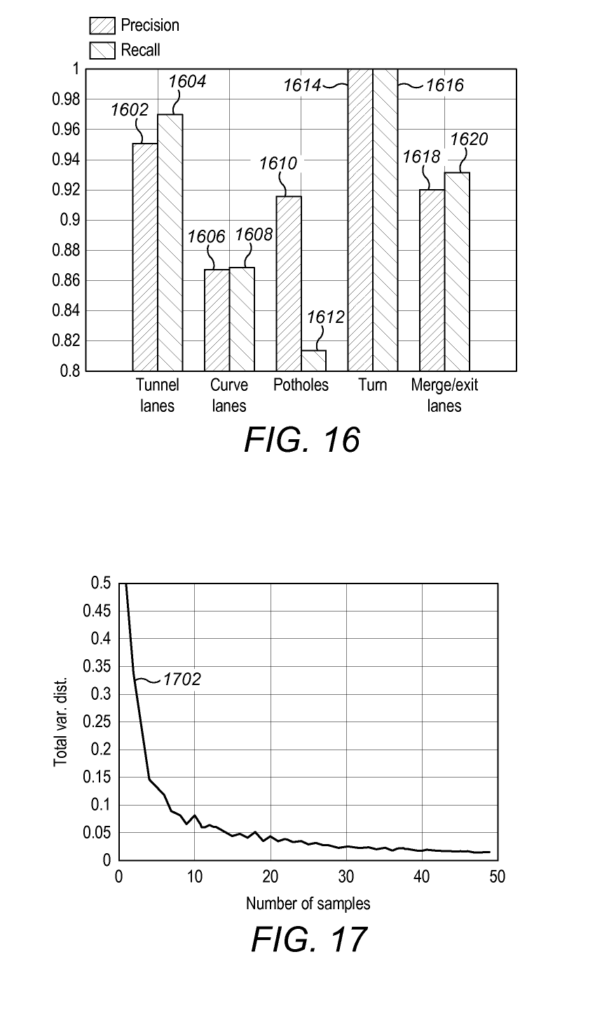

Organic Anchor Detection Accuracy: FIG. 16 provides the precision and recall for the different lane anchors, namely Tunnels 1602/1604, Curves 1606/1608, Potholes 1610/1612, Turns 1614/1616 and Merge/Exits 1618/1620. Note that curves here reflect the accuracy of detecting the correct lane within the curve as opposed to separating the curve from other events in the confusion matrix. FIG. 16 shows that that we can identify the different lane anchors accurately with an average precision and recall of 0.93 and 0.91 respectively.

FIG. 17 shows that using less than 20 points per organic anchor, our two-stage clustering algorithm converges 1702 to a stable lane anchor distribution (reflected by a zero total variation distance between successive distributions). This number is even amortized over the different vehicles that pass by this specific anchor.

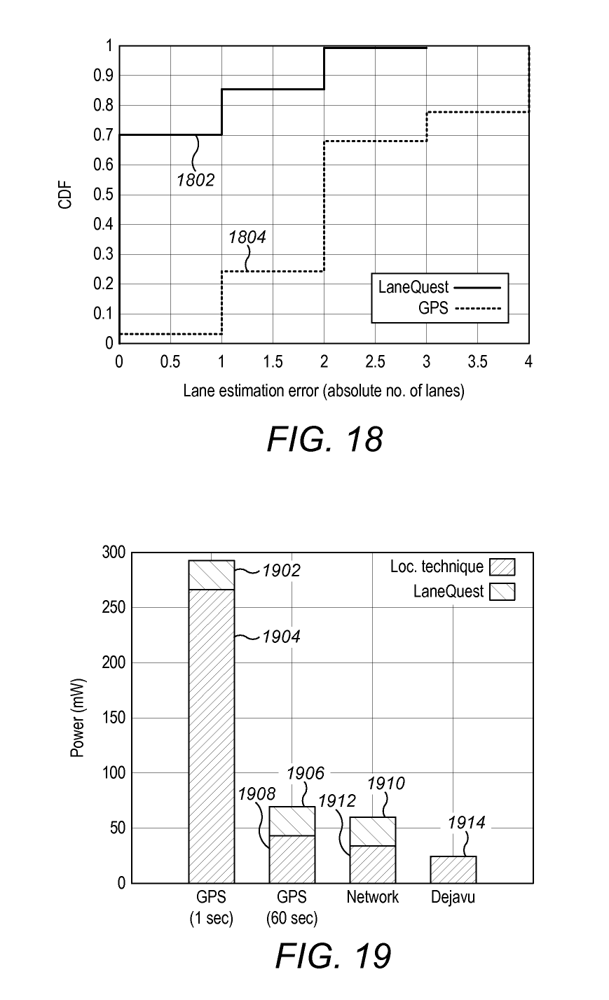

Lane Estimation Accuracy: FIG. 18 shows the cumulative distribution of the lane estimation error for LaneQuest 1802 compared to GPS 1804. For GPS, we take the lane estimate as the closest lane to the reported GPS location. FIG. 18 shows that LaneQuest 1802 can identify the vehicle's exact lane more than 70% of the time. This increases to 89% to within one lane error. On the other hand, the GPS 1804, due to its inaccuracy, biases the lane estimate to the rightmost or leftmost lane, leading to a large error in lane estimation.

Power Consumption: FIG. 19 shows the energy overhead when integrating LaneQuest with other localization systems. The power consumption was calculated using the PowerTutor profiler and the android APIs using the HTC Nexus One cell phone. Even though we implemented LaneQuest on GPS only, we compare its energy consumption with other localization systems based on estimating their energy consumption from the sensors they use. FIG. 19 shows that LaneQuest has a small negligible energy footprint 1902, 1906, and 1910. In addition, when combined with systems that use the inertial sensors for localization, e.g. Dejavu, it consumes zero extra energy. Other localization systems consume very high power as denoted in 1904, 1908, 1912 and 1914. This highlights its suitability for use with the energy-constrained mobile devices.

### INDUSTRIAL APPLICABILITY

Accordingly, the specification and drawings are to be regarded in an illustrative rather than a restrictive sense. The invention is valid for all vehicles and prediction of lane traveled by vehicles in all types of roads. The invention works with all smart phones that are equipped with standard sensors including GPS. The invention does not require any special permission to be generated on the smart devices. The hall mark of the invention is that the innovation works seamlessly and silently in the background without any disturbance to the smart device owners to carry on the sensor data and updating the lane probability. Please note that the procedure works well with smart devices. The invention is directly applicable to the transport industry where accurate prediction of vehicle lane are needed at ground level for people to move about and avoid any possible hindrance such as closure of lanes, congestion, lane changes due to accidents and any possible repair work closures. The invention can be applied to the map industry to provide real-time data to customers on the traffic congestion at lane level granularity.

What is claimed is:

1. A method, comprising:
gathering a raw sensor data residing in inertial sensor of a smart phone and a raw location data using a vehicle sensor to preprocess a location estimate;
applying a local weighted low pass filter method to remove a noise from the raw sensor data and corroborating with the raw location data to produce a raw sensor measurement for a lane change detection;
detecting a lane change event using a x, y and z axis measurement change in the inertial sensor of the smart phone; and
incorporating a lane anchor data gathered using a unsupervised crowd sourcing approach stored in a repository, the raw sensor measurement and the lane change event to calculate a lane position for a specific vehicle using a Markov probabilistic lane detection model without any prior assumption of a starting lane position and to provide real time data to a customer on a road hindrance at a lane level granularity.

2. The method of claim 1, further comprising:
finding the lane position in which the car is travelling based on a lane anchors pre-established in the road.

3. The method of claim 1, further comprising:
increasing the accuracy of the lane prediction through the unsupervised crowd sourcing approach; and
predicting lanes when the vehicle travels through a curve tunnel or passes by a pothole.

4. The method of claim 2, wherein the lane anchors are one of an organic lane anchor and a bootstrap lane anchor.

5. The method of claim 4, further comprising:
calculating the organic lane anchor by applying a spatial clustering on all samples collected from all users that are detected as a curves or pothole;
performing a second level of clustering for the first clustering data points based on lane-discriminating features to determine the lane position for the organic lane anchor; and
constructing a probability distribution from all the reported vehicle lane beliefs for the points within this last resulting feature based clustering step.

6. A system, comprising:
a preprocessing module for gathering a raw sensor data residing in an inertial sensor of a smart phone and raw location data in a sensor of a vehicle and applying a local weighted low pass filter method residing in a smart phone sensor to remove a noise from the raw sensor data and corroborating with the raw location data to produce a raw sensor measurement for a lane change detection;
an event detection module to detect events from a lane change and a lane anchor that the vehicle encounters and updating the lane change and creating a perception model for lane anchor detection and a motion update using the lane change detection;
a repository for the lane anchor are created by unsupervised crowd sensing approach that are created by a user and processed using a two stage clustering and used for the lane anchor detection; and
a probabilistic lane estimation module uses Markov probabilistic lane detection method to predict a lane estimate by using the repository, the perception model, motion update and a current user lane state to provide real time data to a customer on a road hindrance at a lane level granularity.

7. The system of claim 6, wherein the lane anchor is at least one of a bootstrap anchor or an organic anchor.

8. The system of claim 6, further comprising:
the probabilistic lane estimation module to calculate an accurate lane information is done using the Markov probabilistic lane detection method without any prior knowledge of a lane position.

9. (canceled)

10. The system of claim 6, further comprising:
the event detection module to detect a motion event and the lane anchor to feed data into the probabilistic lane estimation module.

11. The method of claim 4, further comprising:
calculating the bootstrap lane anchor by applying a spatial clustering on all samples collected from all users that are detected as a turn, merging and exit lanes and stopping lanes;
performing a second level of clustering for the first clustering data points based on lane-discriminating features to determine the lane position for the bootstrap lane anchor; and
constructing a probability distribution from all the reported vehicle lane beliefs for the points within this last resulting feature based clustering step.
